(19) United States
(12) Patent Application Publication
(10) Pub. No.: US 2012/0298544 A1
(43) Pub. Date: Nov. 29, 2012

(54) DRINKS CONTAINER

(76) Inventor: David Capdevila Pons, Barcelona (ES)

(21) Appl. No.: 13/514,627

(22) PCT Filed: Nov. 23, 2010
(86) PCT No.: PCT/ES10/00475

§ 371 Date: Aug. 14, 2012

(30) Foreign Application Priority Data
Dec. 11, 2009 (ES) P200931145
Jul. 27, 2010 (ES) P201031166

(51) Int. Cl. G09F 3/10; B65D 85/72

(52) U.S. Cl. 206/459.5

(57) ABSTRACT

A glass container has at least a first label of cellulose material stuck to an outside surface of the container by a first adhesive, and a second cellulose label stuck to the container over the first label by a second adhesive, and in contact with the first label such that the force required to unstick the second label is less than the force required to unstick the first label from the outside surface of the container.

The present invention relates to drinks containers.

More particularly, the present invention relates to glass containers, especially drinks bottles of the type having at least a first label made of cellulosic material bonded using an adhesive substance to the outside surface of the bottle.

This is the case, for example, with wine bottles (in their many varieties) and bottles for beer and other drinks (usually alcoholic), which are normally made of glass.

Both wine and beer are beverages of great cultural significance, great importance being attached to the varieties of raw materials used, their production methods and their brand names. Consequently, the collecting of items from the bottles consumed, such as bottle tops and labels, is common practice.

However, the collecting of labels is made very difficult by the current state of the art in the manufacture and placement of labels. In fact, labels intended to provide information about the drink are of cellulosic material, usually porous, so that the label can become damp during use, and the adhesive does not allow the label to be peeled off. As a result, the label normally breaks. These drawbacks can be overcome by special treatment (steam, etc.) that assist in removing the label. However, these methods are not applicable for users in bars and restaurants, where, consequently, users cannot take away the labels for their collections.

There are in existence labels which can be easily removed, in which the label is made from a synthetic material. However, due to commercial and aesthetic requirements in the wine and beer sector, the marketing of quality wines and beers with synthetic labels is not practicable. In current wine labels, the most widely used paper is ‘laid’ paper with different finishes.

Solutions have been proposed in the prior art, for example the proposal in U.S. document 2003/0034645. In this document there are two labels with identical information and of identical size for placement on plastic bottles, the solution proposed in the document being to use a label laminated with a layer of synthetic material and to apply an adhesive to allow interfacial fracture. This solution is not applicable for use in collecting labels as laminating the label changes the properties of feel and elegance which are required in this sector.

Therefore, the problem arises of having an arrangement of labels so that an outer label can be more easily removed from an inner label, affecting as little as possible the integrity of both labels and, in addition, allowing at least one of the labels to retain the physical properties of the cellulosic material.

To provide a solution to the problem, the present invention reveals a new arrangement allowing users to easily remove labels without resorting to synthetic labels.

In particular, the present invention consists of a drinks container of the type made of glass, of the type having at least a first label of cellulosic material bonded with adhesive to the outer surface of the container, characterised in that over the first label is placed a second cellulosic label with an adhesive so that the force required to detach the second label is less than that required to detach the first label from the outer wall of the container.

The present invention also presents the additional advantage of allowing different types of protection against counterfeiting (“anti-fake labels”), which can be placed over the first label, leaving the protection hidden by the second label.

Furthermore, as mentioned above, the user of a drinks container (e.g. a bottle of wine), can easily remove the second label and in this way identify the beverage for subsequent consumption.

Preferably, the substance between the first and the second label will be an adhesive of the type which undergoes interfacial fracture when the second label is removed from the first.

Also preferably, the two adhesive substances will be different from each other.

In a particular embodiment, the second label will have a substantially larger size than the first label and an adhesive strip will be located on the periphery of the second label using a substance with a coefficient of adhesion greater than that of the substance placed on the inside surface of the label, i.e. the second label is bonded using a substance with a greater adherence to the container than to the label thereby facilitating removal of the second label without damaging the integrity of the first label. Especially preferably, the material of the strip will include a plastic derivate.

In an advantageous embodiment, the second label will have a surface area equal to or greater than that of the first label, so that the second label completely covers the first label.

Equally advantageously, the first and second labels will bear the same information on their outer faces.

It should be noted that the present invention allows at least the second cellulosic label of a bottle to be porous. Both labels may be the same.

For a better understanding, drawings of an embodiment of the drinks container forming the object of the present invention are appended by way of explanatory but non-limiting example.

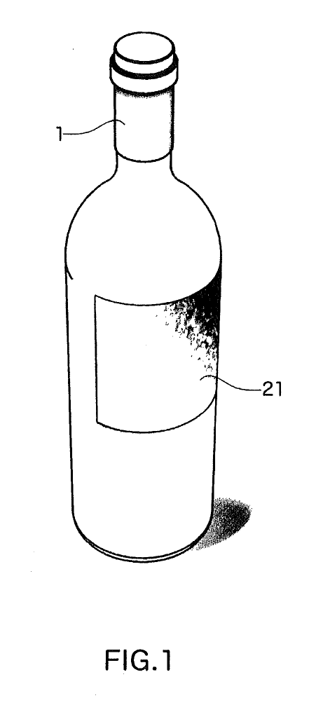

FIG. 1 is a perspective view of a bottle according to the present invention.

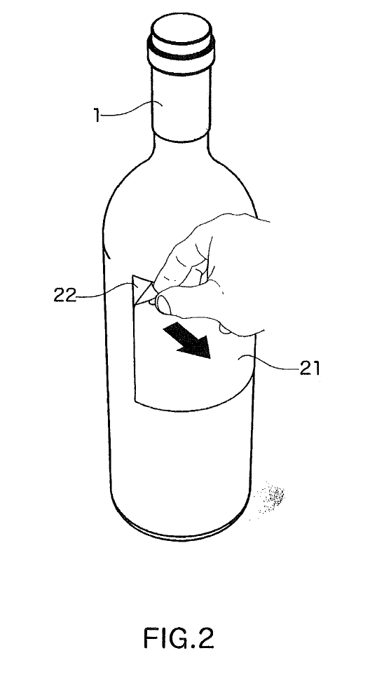

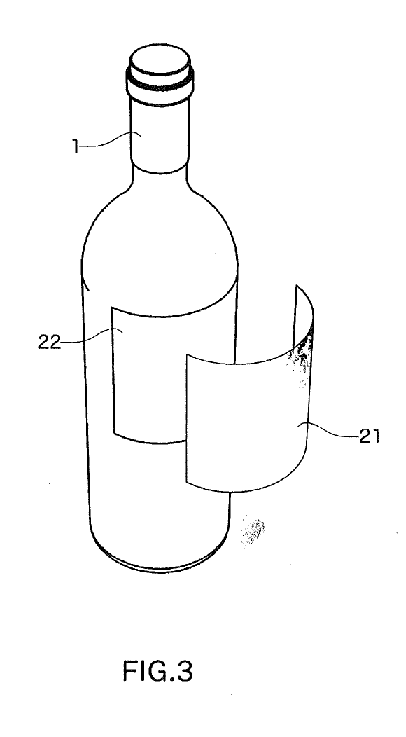

FIGS. 2 and 3 show the process of removing the second label from the bottle according to the present invention.

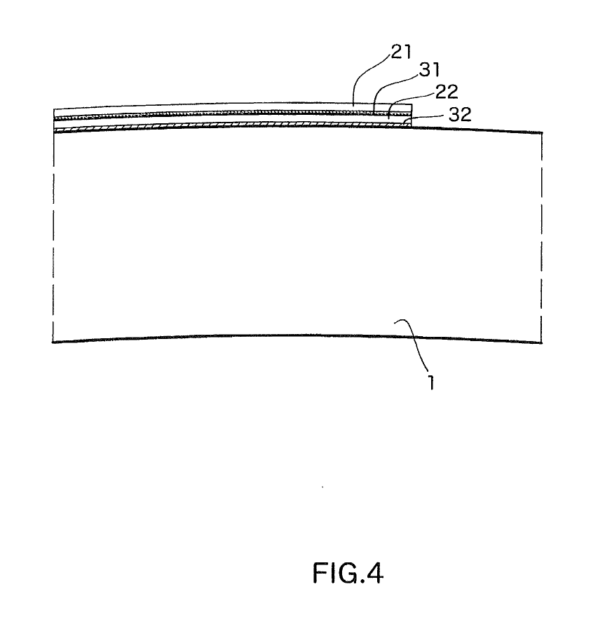

FIG. 4 is a sectional view which shows the arrangement of adhesive layers and labels on a bottle surface.

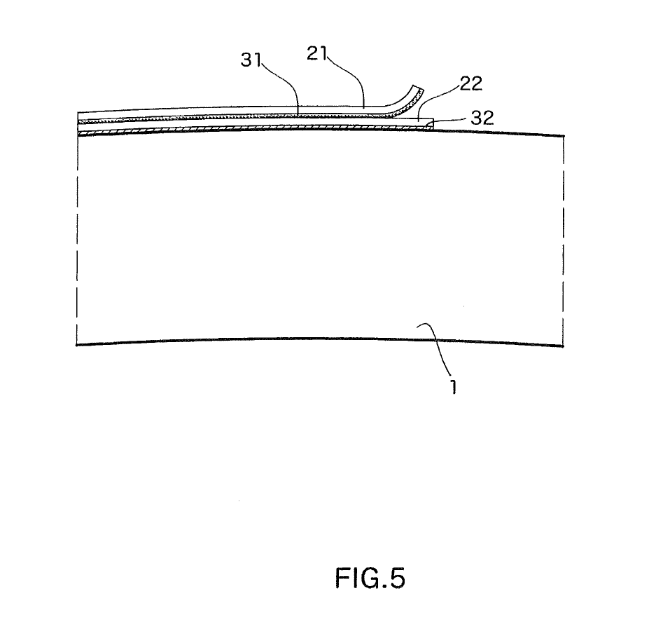

FIG. 5 corresponds to FIG. 4, showing a process of separation of the second label in which the adhesive substance undergoes an interfacial fracture.

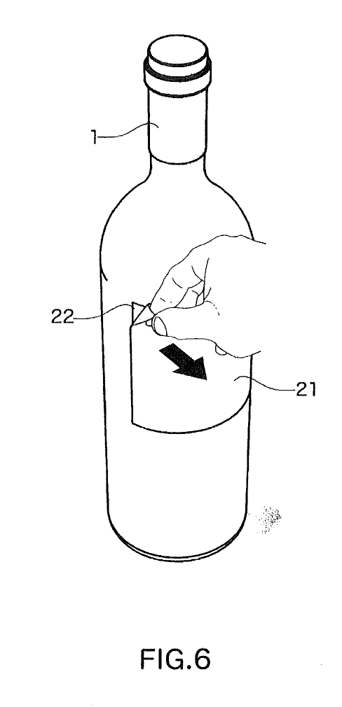

FIG. 6 is a perspective view of another bottle according to the present invention.

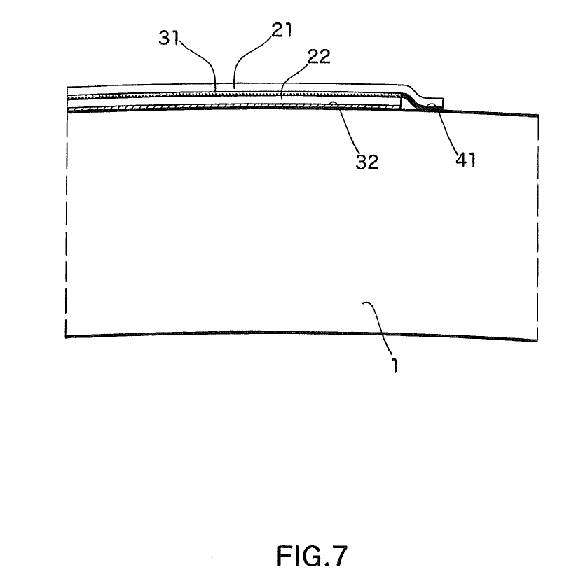

FIG. 7 is a sectional view which shows the arrangement of adhesive layers and labels on a bottle surface.

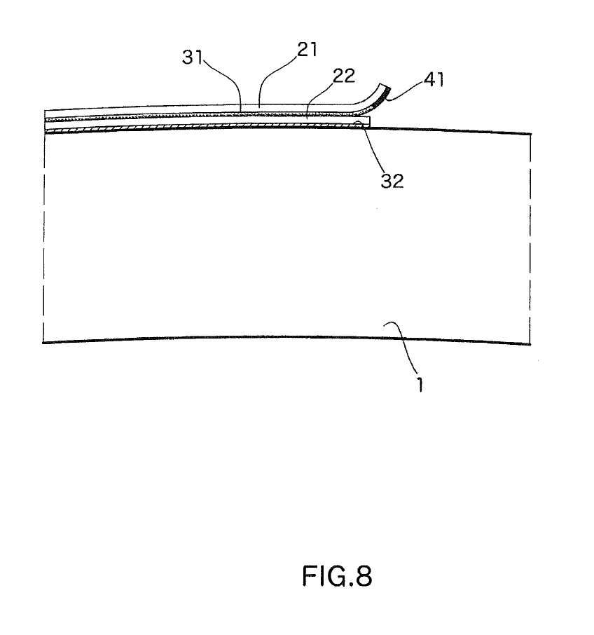

FIG. 8 corresponds to FIG. 7, showing a process of separating the second label in which the adhesive substance undergoes an interfacial fracture.

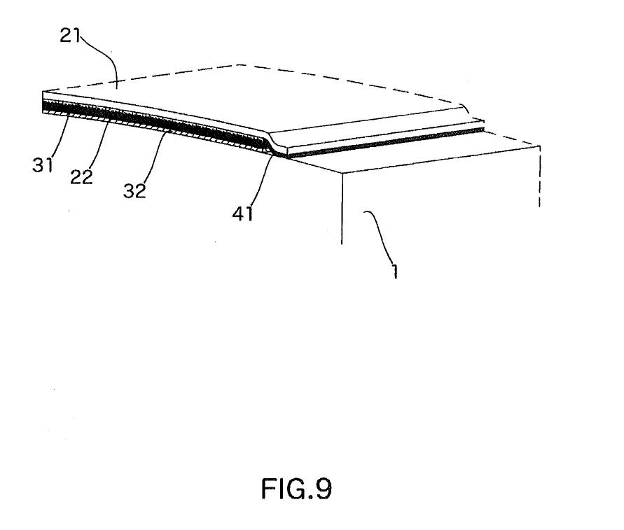

FIG. 9 is a perspective view of FIG. 7,

FIGS. 1 to 5 show an embodiment of the present invention.

FIGS. 1 to 3 show a glass bottle (1), e.g. a bottle intended to receive wine, champagne or beer, which has an outer label (21) of the traditional type. This second or traditional label (21) is bonded to a first inner label (22) which in turn is bonded to the outer wall of the bottle (1). The second label (21) can be peeled off without also peeling off the first label (22). In the example shown, both labels are identical, containing the same information. This allows, for example, a customer in a restaurant to remove the label and the bottle will still retain the information on the label. The first label (22) can be blank, and he of equal, greater or lesser size than the traditional label or second label (21).

In the case shown, the second label (21) can be porous, like traditional labels, and the first label can be of any suitable material which favours removal of the second label or original label (21) from the first label (22). In the case shown, both labels (21) and (22) are the same.

FIGS. 4 and 5 show the distribution of adhesive layers and labels from the example shown in FIGS. 1 to 3. The adhesives (31) and (32) which bond the first label (22) to the bottle (1) and the second label (21) to the first (22) are preferably different substances. The adhesive substance (31) that bonds the two labels (21) and (22) is a substance which preferably is peeled off by interfacial fracture, as shown in FIG. 5. To this end, either the rear face of the second label (21) or the outer face of the first label can have a special finish to favour this embodiment.

FIGS. 6-9 show a glass bottle (1), which has a main outer label (21) of traditional type. This second label or traditional label (21) is preferably attached to a first label (22) which is in turn bonded to the outer wall of the bottle (1). The second label (21) can be peeled off without also peeling off the first label (22). In this embodiment, the second label has a greater size than the first, and contains the same information. This allows, for example, a customer in a restaurant to remove the label and the bottle will not lack the information referring to the label. The first label (22) can also be blank, and be of equal or lesser size than the traditional label or second label (21).

In the case shown, the second label (21) can be porous, like traditional labels, and the first label may be of any suitable material which favours removal of the second label or main label (21) from the first label (22). In the case shown, the second label (21) is larger than the first label (22).

FIGS. 7 to 9 show the distribution of adhesive layers and labels from the example shown in FIG. 6. The adhesives (31) and (32) which bond the first label (22) to the bottle (1) and the second label (21) to the first (22) are preferably different substances. The adhesive substance (31) that bonds the two labels (21) and (22) is a substance which preferably is peeled off by interfacial fracture, as shown in FIG. 5.

To this end, either the rear face of the second label (21) or the outer face of the first label can have a special finish to favour this embodiment. In a particularly preferred embodiment, between the second label (21) and the first label (22) there is no adhesive substance, further facilitating detachment of the second label (21).

Multiple variants of the example described are possible. For example, the labels may be wholly or partly bonded, with combinations of different adhesives, for example. The label support is a bottle in any of its variants (jar, small bottle, etc.) and the final product contained may also vary.

FIG. 9 shows a perspective view of FIG. 7, in which the second label (21) has a substantially greater size than the first label (22). On the back of the second label (21) there is an adhesive strip (41) so positioned that only the edge of the second label is bonded, by means of the strip (41), to the container (1), the remainder of the label (21) being bonded using an adhesive (31) with little adhesive capacity which allows interfacial fracture without damaging the integrity of the first label (22). In a preferred embodiment, one part of the strip (41) bonds the second label (21) to the container (1) and the other part of the strip (41) is in contact with the first label (22). Even more preferably, the first label (22) and the second label (21) have the same size and the strip (41) is positioned so as to bond the first label (22) to the second label (21) only by its peripheral edges. Even more preferably, between the two labels (21) and (22) there is no adhesive substance (31) between the labels, which are attached only by means of the strip (41).

Multiple variants of the embodiments described are possible. For example, the labels may be wholly or partly bonded, with combinations of different adhesives, for example. The label support is a bottle in any of its variants (jar, small bottle, etc.) and the final product contained may also vary.

While the invention has been described with respect to examples of preferred embodiments, these should not be considered limitations of the invention, which will be defined by the broadest interpretation of the following claims.

1. A glass container, comprising: at least a first label of cellulosic material bonded with a first adhesive to an outer surface of the container, and wherein a second cellulosic label is placed over the first label, and kept in contact with the first label by a second adhesive such that the force required to detach the second label is less than that required to detach the first label from the outer surface of the container.

2. A container according to claim 1, wherein the second adhesive between the first and second labels of a type which undergoes interfacial fracture when the second label is peeled off the first label.

3. A container according to claim 1, wherein the first and second adhesives are different from each other.

4. A container according to claim 1, wherein the second label has a surface area equal to or greater than that of the first label, and the second label completely covers the first label.

5. A container according to claim 4, wherein the second label has a surface area greater than that of the first label, and the second label completely covers the first label.

6. A container according to claim 5, wherein the second label has an adhesive area in the form of a strip, covering the periphery of the back of the second label in such a way that the strip keeps both the first and the second label attached to the container.

7. A container according to claim 6, wherein the strip includes a material derived from plastic.

8. A container according to claim 6, wherein the adhesive strip is positioned so that it makes contact only with the container.

9. A container according to claim 6, wherein the said adhesive strip is positioned so that it makes contact with the container and the first label.

10. A container according to claim 1, wherein the first and second labels bear the same information on their outer faces.

11. A container according to claim 1, wherein at least the second cellulosic label is porous.

12. A container according to any of the claim 1, wherein the second label is completely detachable from the first.

13. A container according to claim 1, wherein both labels are the same.

14. A container according to claim 1, wherein it is a bottle.

15. (canceled)
